(19) United States
(12) Patent Application Publication
(10) Pub. No.: US 2026/0237099 A1
(43) Pub. Date: Aug. 13, 2026

(54) COMPUTING AT LEAST ONE CALIBRATION PARAMETER OF A CAMERA

(71) Applicant: Telefonaktiebolaget LM Ericsson (publ), Stockholm (SE)

(72) Inventors: Marcus Valtonen Örnhag, Lund (SE); Stefan Adalbjörnsson, Austin, TX (US)

(21) Appl. No.: 19/052,726

(22) Filed: Feb. 13, 2025

(51) Int. Cl. G06T 7/90

(52) U.S. Cl. CPC G06T 7/90

(57) ABSTRACT

It is provided a method for computing at least one calibration parameter of a camera. The method is performed by a calibration determiner. The method includes acquiring an image captured by a camera. The method further includes receiving localisation data comprising a pose, consisting of a position and orientation in a pre-defined coordinate system, the pose concerning a point being fixed in relation to the camera. The method further includes computing at least one calibration parameter for the camera based on the image and the localisation data. The at least one calibration parameter includes at least one intrinsic parameter and/or at least one distortion coefficient for the camera.

### TECHNICAL FIELD

The present disclosure relates to the field of cameras, and in particular to computing at least one calibration parameter of a camera.

### BACKGROUND

Localisation and mapping, such as SLAM (simultaneous localisation and mapping) is used for many types of mobile devices, such as for extended reality (XR) devices, encompassing augmented reality (AR) and virtual reality (VR) devices, as well as self-driving cars, unmanned aerial vehicles, robots, etc, hereinafter referred to as mobile devices. Localisation is the process of determining the pose of a device/object in space, where pose is defined as the combination of position and orientation, i.e. 6 degrees of freedom (6DOF). Mapping is the process of mapping the real world in a data structure.

When cameras are used for localisation, e.g. in SLAM, they need to be calibrated to achieve sufficient accuracy. Many lenses, particularly wide-angle models, introduce radial distortion that bends light rays more near the image periphery. These distortions manifest as “barrel” or “pincushion” warping of straight lines. Furthermore, tangential distortion can arise if the lens or sensor is slightly tilted, shifting points laterally across the image plane. Intrinsic parameters that may need to be calibrated can include focal length, principal point, skew and/or aspect ratio.

Failure in proper calibration of cameras can result in inaccurate or failed localisation. Furthermore, environmental and mechanical changes may shift camera characteristics over time, necessitating periodic checks or in-field recalibration procedures. Some minimal solvers can jointly estimate distortion models together with camera pose. A general approach is presented which can handle rational models of arbitrary degree for both distortion and undistortion.

These solvers can be used for obtaining calibration parameters, and is based on solving full 6-DOF models. The calculation is heavy, resulting in long computation times, preventing such solvers from running in real-time on XR hardware. This cannot be solved by increasing processing power in the mobile device. Increased power consumption is not acceptable as a solution, since a key technology hurdle for widespread XR use is to reduce the size of the device to get as close as possible to the form factor of normal glasses.

### SUMMARY

One object is to compute at least one calibration parameter of a camera in a more efficient manner than in the prior art.

According to a first aspect, it is provided a method for computing at least one calibration parameter of a camera, the method being performed by a calibration determiner. The method comprises: acquiring an image captured by a camera; receiving localisation data comprising a pose, consisting of a position and orientation in a pre-defined coordinate system, the pose concerning a point being fixed in relation to the camera; and computing at least one calibration parameter for the camera based on the image and the localisation data, wherein the at least one calibration parameter comprises at least one intrinsic parameter and/or at least one distortion coefficient for the camera.

The computing at least one calibration parameter may comprise: determining at least one match set, in which one 3D point of a feature in a 3D space of the pre-defined coordinate system, matches a corresponding 2D image point coordinate of the feature in the image; and calculating the at least one calibration parameter for the camera based on the at least one match set and the pose.

The calculating at least one calibration parameter may comprise determining, for each match set, a 2D projection of the 3D point of the feature, onto a plane corresponding to the image. In this case the 2D projection is based on the pose; and the at least one calibration parameter is calculated based on comparing the 2D projection of the 3D point of the feature with 2D image point coordinate of the feature.

The 2D projection may be computed based on a pinhole camera model.

The computing at least one calibration parameter may be repeated until an exit condition is true to obtain a plurality of candidate sets of calibration parameter(s). In this case, the method further comprises: selecting a set of calibration parameter(s) from the plurality of candidate sets of calibration parameter(s).

The localisation data may be based on sensor data from an inertial measurement unit being fixed in relation to the camera, and a previously known pose based on a global navigation satellite system, GNSS, the sensor data at least covering a time after the previously known pose.

The localisation data may be determined using orientation and/or distance indicators that are determined based on radio frequency, RF, signals from one or more fixed RF transceiver stations.

The computing the at least one calibration parameter may comprise estimating at least one parameter of a radial distortion of the camera, based on finding a minimum of a linear expression.

The computing the at least one calibration parameter may comprise estimating a vector θ comprising the at least one calibration parameters according to the expression:

$${min}_{θ} {‖ M θ - b ‖}^{2} ,$$

where M is a matrix and b is a vector, wherein the elements of M and b are derived from the at least one match set.

The length of vector b may be the same as the length of vector θ, in which case the matrix M is a square matrix whose sides are the same length as the length of vector θ.

The at least one calibration parameter may comprise tangential distortion parameters.

The method may may further comprise:
refining initial pose estimates over an established inlier set.

According to a second aspect, it is provided a calibration determiner for computing at least one calibration parameter of a camera. The calibration determiner comprises: processing circuitry; and memory circuitry storing instructions that, when executed by the processing circuitry, cause the calibration determiner to: acquire an image captured by a camera; receive localisation data comprising a pose, consisting of a position and orientation in a pre-defined coordinate system, the pose concerning a point being fixed in relation to the camera; and compute at least one calibration parameter for the camera based on the image and the localisation data, wherein the at least one calibration parameter comprises at least one intrinsic parameter and/or at least one distortion coefficient for the camera.

The instructions to compute at least one calibration parameter may comprise instructions that, when executed by the processing circuitry, cause the calibration determiner to: determine at least one match set, in which one 3D point of a feature in a 3D space of the pre-defined coordinate system, matches a corresponding 2D image point coordinate of the feature in the image; and calculate the at least one calibration parameter for the camera based on the at least one match set and the pose.

The instructions to calculate at least one calibration parameter may comprise instructions that, when executed by the processing circuitry, cause the calibration determiner to determine, for each match set, a 2D projection of the 3D point of the feature, onto a plane corresponding to the image, wherein the 2D projection is based on the pose; and wherein the at least one calibration parameter is calculated based on comparing the 2D projection of the 3D point of the feature with 2D image point coordinate of the feature.

The 2D projection may be computed based on a pinhole camera model.

The calibration determiner may further comprises instructions that, when executed by the processing circuitry, cause the calibration determiner to repeat the instructions to compute at least one calibration parameter until an exit condition is true to obtain a plurality of candidate sets of calibration parameter(s). In this case, the calibration determiner further comprises instructions that, when executed by the processing circuitry, cause the calibration determiner to select a set of calibration parameter(s) from the plurality of candidate sets of calibration parameter(s).

The localisation data may be based on sensor data from an inertial measurement unit being fixed in relation to the camera, and a previously known pose based on a global navigation satellite system, GNSS, the sensor data at least covering a time after the previously known pose.

The localisation data may be determined using orientation and/or distance indicators that are determined based on radio frequency, RF, signals from one or more fixed RF transceiver stations.

The instructions to compute the at least one calibration parameter may comprise instructions that, when executed by the processing circuitry, cause the calibration determiner to estimate at least one parameter of a radial distortion of the camera, based on finding a minimum of a linear expression.

The instructions to compute the at least one calibration parameter may comprise instructions that, when executed by the processing circuitry, cause the calibration determiner to estimate a vector θ comprising the at least one calibration parameters according to the expression:

$${min}_{θ} {‖ M θ - b ‖}^{2} ,$$

where M is a matrix and b is a vector, wherein the elements of M and b are derived from the at least one match set.

The length of vector b may be the same as the length of vector θ, in which case the matrix M is a square matrix whose sides are the same length as the length of vector θ.

The at least one calibration parameter may comprise tangential distortion parameters.

The calibration determiner may further comprise instructions that, when executed by the processing circuitry, cause the calibration determiner to refine initial pose estimates over an established inlier set.

According to a third aspect, it is provided a computer program for computing at least one calibration parameter of a camera. The computer program comprises computer program code which, when executed on a calibration determiner causes the calibration determiner to: acquire an image captured by a camera; receive localisation data comprising a pose, consisting of a position and orientation in a pre-defined coordinate system, the pose concerning a point being fixed in relation to the camera; and compute at least one calibration parameter for the camera based on the image and the localisation data, wherein the at least one calibration parameter comprises at least one intrinsic parameter and/or at least one distortion coefficient for the camera.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-C are schematic diagrams illustrating embodiments of where the calibration determiner can be implemented;

FIG. 3 is a schematic diagram illustrating components of the mobile device of FIG. 1 according to one embodiment;

FIG. 4 is a schematic diagram illustrating components of the calibration determiner FIGS. 2A-C;

FIGS. 5A-C are flow charts illustrating embodiments of methods for computing at least one calibration parameter of a camera;

FIG. 6 is a schematic diagram showing functional modules of the calibration determiner of FIGS. 2A-C according to one embodiment;

FIG. 7 shows one example of a computer program product comprising computer readable means;

FIGS. 8A-D are graphs illustrating distribution of pose errors for embodiments presented herein compared to the prior art for a few sample cases; and

FIG. 9 is a schematic graph illustrating cumulative distribution of execution time for embodiments presented herein compared to the prior art.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, calibration parameter(s) for a camera is calculated by exploiting a known pose. Compared to the known calculations of calibration parameters, the solution according to embodiments presented herein is significantly more efficient and more accurate, enabling such calibration to be performed on the camera device, such as an XR headset, or vehicle with superior performance.

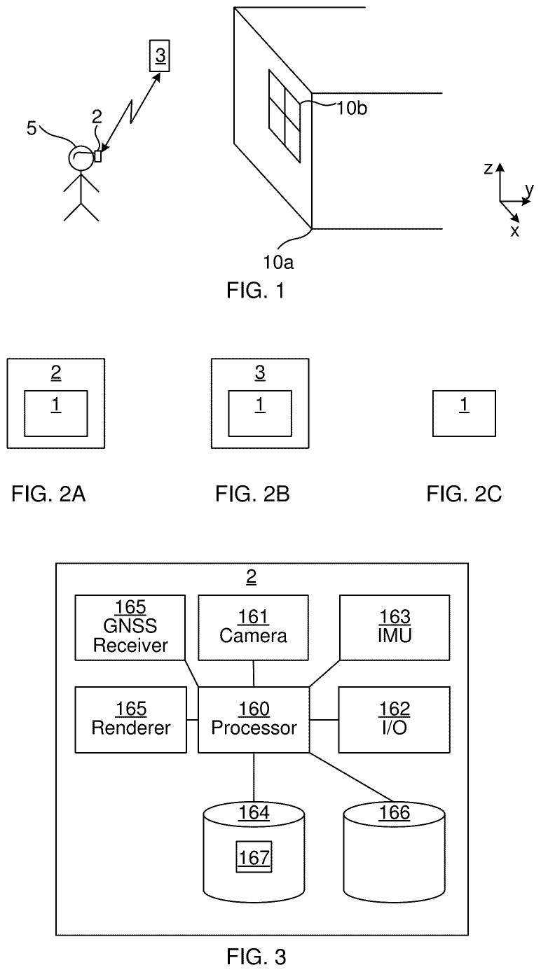

FIG. 1 is a schematic diagram illustrating an environment in which embodiments presented herein can be applied. In the example illustrated in FIG. 1, there is a user 5 with a mobile device 2. The mobile device 2 can be a wearable device, such as smart glasses, head-mounted display (HMD), or the mobile device 2 can be a smartphone, car, etc. The mobile device 2 can also be provided without a user, e.g. in the form of an unmanned aerial (or ground) vehicle or robot.

One or more servers 3 can be provided with ability to communicate with the mobile device 2, as well as other mobile devices (not shown). The communication can e.g. be based on any one or more wireless or wired-based technology, such as a cellular network, any of the IEEE 802.11x standards (also known as Wi-Fi), using Bluetooth or Bluetooth Low Energy (BLE), ZigBee, Ethernet, optical communication, etc. The cellular communication network can e.g. comply with any one or a combination of sixth generation (6G) networks, next generation mobile networks (fifth generation, 5G), LTE (Long Term Evolution), or any other current or future wireless network, as long as the principles described hereinafter are applicable.

In the environment around the user, there are a number of visual features 10a-b, e.g. a first visual feature 10a in the form of a corner of a building, and a second visual feature 10b in the form of a corner of a window. There may be many more (or fewer) visual features depending on the location of the user 5 and feature detection capabilities of the mobile device 2.

The mobile device 2 can be configured to perform localisation and mapping e.g. based on SLAM using one or more sensors, such as a camera, GNSS (global navigation satellite system) receiver, IMU (inertial measurement unit), etc. By performing localisation and mapping, the mobile device is able to calculate its pose with respect to the physical space. Pose is a term that includes both translation in three dimensions and orientation in three dimensions.

When using a camera for localisation, it needs to be calibrated to achieve sufficient accuracy. While there are known methods for determining one or more calibration parameters for such calibration, there is a need for methods for determining calibration parameters that are more efficient and more accurate than those in the prior art. Furthermore, it would be greatly beneficial to provide a solution to determining calibration parameters that are not dependent on a particular visual setting, such as a checkerboard. According to embodiments presented herein, a calibration determiner is used to determine one or more calibration parameters for the camera.

FIGS. 2A-C are schematic diagrams illustrating embodiments of where the calibration determiner 1 can be implemented.

In FIG. 2A, the calibration determiner 1 shown as implemented in the mobile device 2. The mobile device 2 is thus the host device for the calibration determiner 1 in this implementation.

In FIG. 2B, the calibration determiner 1 shown as implemented in the server 3. The server 3 is thus the host device for the calibration determiner 1 in this implementation.

In FIG. 2C, the calibration determiner 1 is shown as implemented as a stand-alone device. The calibration determiner 1 thus does not have a host device in this implementation.

FIG. 3 is a schematic diagram illustrating components of the mobile device 2 of FIG. 1 according to one embodiment. Processing circuitry 160 is provided using any combination of one or more of a central processing unit (CPU), graphics processing unit (GPU), multiprocessor, neural processing unit (NPU), microcontroller, digital signal processor (DSP), etc., capable of executing software instructions 167 stored in memory circuitry 164, which can thus be a computer program product. The processing circuitry 160 could alternatively be implemented using an application specific integrated circuit (ASIC), field programmable gate array (FPGA), etc.

The memory circuitry 164 can be any combination of random-access memory (RAM) and/or read-only memory (ROM). The memory circuitry 164 also comprises persistent storage, which, for example, can be any single one or combination of magnetic memory, optical memory, solid-state memory or even remotely mounted memory.

A data memory 166 is also provided for reading and/or storing data during execution of software instructions in the processing circuitry 160. The data memory 166 can be any combination of RAM and/or ROM.

A GNSS receiver is capable of determining a location based on GNSS signals such as GPS (global positioning system) signals, Galileo, GLONASS (globalnaya navigatsionnaya sputnikovaya sistema), BeiDou, etc. A camera 161 is capable of capturing still and/or moving images of the environment around the user 5, at least in two dimensions (2D). The camera 161 can e.g. be based on capturing visual light, IR light and/or is based on lidar or radar technology. An inertial measurement unit (IMU) 163 is provided to determine linear acceleration and/or angular velocity (via a gyroscope) of the mobile device 2.

A renderer 165 can be provided for rendering visual data to the user 5, e.g. in the form of a head-mounted display, a touch screen or a traditional display. The mobile device 2 further comprises an I/O interface 162 for communicating with external and/or internal entities using wired communication, and/or wireless communication, such as with the server 3 and a wide area network such as the Internet.

Other components of the mobile device 2 are omitted in order not to obscure the concepts presented herein.

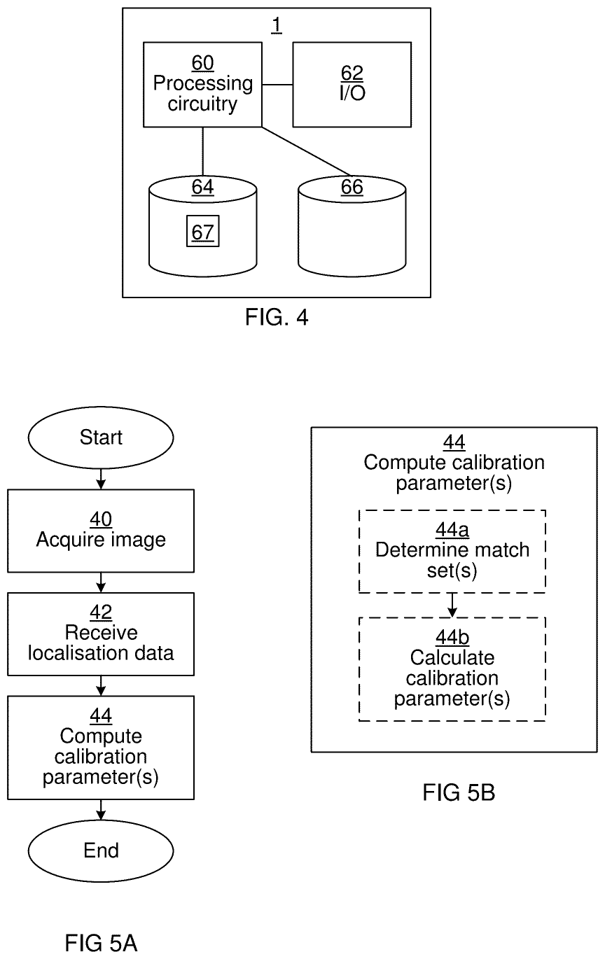

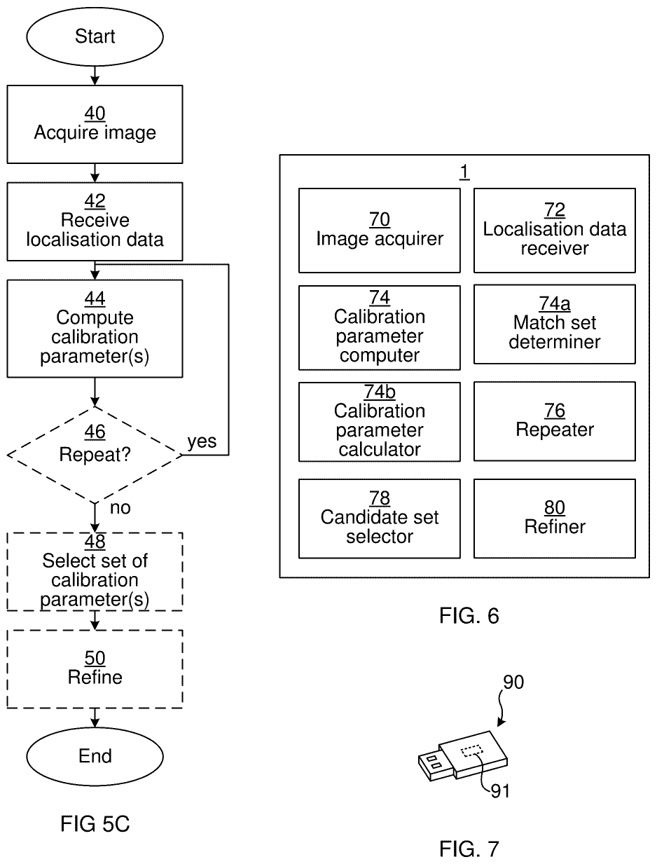

FIG. 4 is a schematic diagram illustrating components of the calibration determiner 1 FIGS. 2A-C. It is to be noted that when the calibration determiner 1 is implemented in a host device, such as the mobile device 2 or the server 3, one or more of the mentioned components can be shared with the host device. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in memory circuitry 64, which can thus be a computer program product. The processing circuitry 60 could alternatively be implemented using an application specific integrated circuit (ASIC), field programmable gate array (FPGA), etc. The processing circuitry 60 can be configured to execute the method described with reference to FIGS. 5A-C below.

The memory circuitry 64 can be any combination of random-access memory (RAM) and/or read-only memory (ROM). The memory circuitry 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, Bluetooth, Bluetooth Low Energy, and/or a cellular network, complying with any one or a combination of 6G mobile networks, 5G mobile networks, LTE, or any other current or future wireless network, as long as the principles described hereinafter are applicable.

Other components are omitted in order not to obscure the concepts presented herein.

FIGS. 5A-C are flow charts illustrating embodiments of methods for computing at least one calibration parameter of a camera. The method is performed by a calibration determiner 1. First, embodiments illustrated by FIG. 5A will be described.

In an acquire image step 40, the calibration determiner 1 acquires an image captured by a camera 161 (of a mobile device 2). Since the image is acquired using the camera, the image contains distortions and/or effects of intrinsic parameters of the camera.

In a receive localisation data step 42, the calibration determiner 1 receives localisation data comprising a pose. As described above, the pose consists of a position (in three dimensions) and orientation (in three dimensions) in a pre-defined coordinate system. Equivalently, the pose may also be expressed as the combination of translation and rotation. The pose concerns a point being fixed in relation to the camera 161. For instance, the pose may be for a specific point of the camera 161, such as a central point of the camera, or for a point of an equipment, such as an XR headset, or vehicle, to which the camera 161 is fixedly mounted.

The localisation data may be based on sensor data from an IMU 163 which is also fixed in relation to the camera 161, and a previously known pose based on GNSS. The sensor data covers (at least) a time after the previously known pose. In this way, the localisation data can be determined also for period of GNSS outage. Alternatively or additionally, the localisation data is determined using orientation and/or distance indicators, such as angle of arrival, time of arrival, etc., that are determined based on RF (radio frequency), signals from one or more fixed RF transceiver stations. The fixed RF transceiver stations can be base stations and/or access points.

In a compute calibration parameter(s) step 44, the calibration determiner 1 computes at least one calibration parameter for the camera 161 based on the image and the localisation data. The at least one calibration parameter comprises at least one intrinsic parameter and/or at least one distortion coefficient for the camera 161.

The computing the at least one calibration parameter can comprise estimating at least one parameter of a radial distortion of the camera 161, based on finding a minimum of a linear expression.

Optionally, the at least one calibration parameter can comprise tangential distortion parameters.

Looking now to FIG. 5B, it is there illustrated optional sub-steps of the compute calibration parameter(s) step 44.

In an optional determine match set(s) step 44a, the calibration determiner 1 determines at least one match set, in which one 3D point of a feature in a 3D space of the pre-defined coordinate system, matches a corresponding 2D image point coordinate of the feature in the image. For instance, each 3D point of a map may be stored together with one or more local feature descriptors that were originally used to create it. When a new camera image arrives, 2D features in that image may be detected and corresponding descriptors are computed. By matching these new descriptors to the stored map descriptors, the matching may hypothesize which 3D points correspond to which 2D features. The matching can e.g. be performed based on algorithms known per se for this purpose, such as k nearest neighbours or FLANN (fast library for approximate nearest neighbours). Hence, each such pair of a 3D point and a corresponding 2D image point is here denoted a match set. For each 2D image, there can be any number of determined match sets.

In an optional calculate calibration parameter(s) step 44b, the calibration determiner calculates the at least one calibration parameter for the camera 161 based on the at least one match set and the pose.

In one embodiment, the calculating the at least one calibration parameter comprises determining, for each match set, a 2D projection of the 3D point of the feature, onto a plane corresponding to the image. The 2D projection is based on the pose. In one embodiment, the 2D projection is computed based on a pinhole camera model. In this way, an undistorted 2D projection of the 3D point and the distorted 2D point can be obtained, whose location depends on distortion parameters and intrinsic parameters of the camera. This enables the calculation of one or more calibration parameters. In other words, the at least one calibration parameter may be calculated based on comparing the (ideal) 2D projection of the 3D point of the feature with (camera distorted) 2D image point coordinate of the feature.

In one embodiment, the computing the at least one calibration parameter comprises estimating a vector θ comprising the at least one calibration parameters according to the expression:

$${min}_{θ} {‖ M θ - b ‖}^{2} ,$$

where M is a matrix and b is a vector, wherein the elements of M and b are derived from the at least one match set.

The length of vector b can be the same as the length of vector θ, in which case the matrix M is a square matrix whose sides are the same length as the length of vector θ. More details of how M and b can be derived is disclosed below.

Looking now to FIG. 5C, some optional additional steps are shown. Only steps that are new or modified compared to FIGS. 5A-B will be described.

In an optional conditional repeat step 46, the calibration determiner 1 determines whether an exit condition is true. The exit condition can be that a certain number of candidate sets of calibration parameter(s) have been obtained. This number can be a fixed number or can be derived based on the number of matching sets that are available based on the image. Alternatively, this number may be an estimation based on the statistical probability to select an all inlier match set, given an assumed outlier ratio.

If the exit condition is not true, the method returns to the compute calibration parameter(s) step 44 but for another instance of match sets to obtain a new candidate set of calibration parameter(s). When the exit condition is true, the method proceeds to an optional select set of calibration parameter(s) step 48, or the method ends.

In an optional select set of calibration parameter(s) step 48, the calibration determiner 1 selects the best set of calibration parameter(s) from a plurality of candidate sets of calibration parameter(s).

In some more detail, this selection can be performed according to the following, RANSAC (random sample consensus)-like framework. After estimating the calibration parameter(s) for a number of different match sets, this results in multiple candidate sets of calibration parameter(s). Each candidate set of calibration parameter(s) is then tested for a larger amount, or even all, of the match sets for the image, to determine an estimated 2D point where each 3D point would project onto the image based on applying the calibration parameter(s). The estimated 2D point is thus the result of the model resulting from the calibration parameter(s) of that candidate set. For each match set, an error can then be calculated as the distance from the estimated 2D point to the actual 2D point in the captured image. When the error is less than a threshold error (e.g. threshold distance in pixels), this is denoted an inlier, and when the error is greater than the threshold error, this is denoted an outlier. The same procedure is repeated for all candidate sets of calibration parameters, after which the best performing candidate set of calibration parameters is selected, e.g. with the smallest number of outliers.

Using this procedure, each candidate set of calibration parameter(s) may be efficiently calculated using a solver for a separate set of match points, and the best candidate set of calibration parameters may subsequently be robustly selected.

In an optional refine step 50, the calibration determiner 1 refines initial pose estimates over an established inlier set of the selected set of calibration parameter(s). For instance, a cost function may be calculated as an aggregated error based on the inliers of the selected set of calibration parameters. The calibration parameters may then be optimised to minimise the aggregated error, e.g. using Levenberg-Marquardt, Gauss-Newton, etc. to iteratively reduce the aggregated error until a minimum in the aggregated error is reached.

Embodiments presented herein will now be illustrated with a more detailed walk-through of how camera parameter(s) can be derived for calibration.

The absolute pose problem seeks to find the best matching pose P from known 3D points Xᵢ and corresponding 2D image points xᵢ. Using the terminology above, a 3D points Xᵢ and its matching 2D image points xᵢ are collectively called a match set. Given a known pose P=[R|t], if a pinhole camera model is used, this must obey

$${K}^{- 1} {x}_{i} = π ( R {X}_{i} + t ) , \qquad ( 1 )$$

where π is the pinhole projection, K is an intrinsic camera matrix, R is rotation and t is translation. It is to be noted that any other suitable 3D to 2D projection can be used. Two parametric distortion models include the undistortion model

$$D ( {K}^{- 1} {x}_{i} ) = π ( R {X}_{i} + t ) , \qquad ( 2 )$$

and the distortion model

$${K}^{- 1} {x}_{i} = D ( π ( R {X}_{i} + t ) ) , \qquad ( 3 )$$

where D is a non-linear distortion mapping, which can be approximated with a rational function

$$h ( r ) = \frac{1 + {\sum }_{i} {μ}_{i} {r}^{2 i}}{1 + {\sum }_{i} {λ}_{i} {r}^{2 i}} , \qquad ( 4 )$$

such that D(x)=h(∥×∥)x. We denote distortion solvers D(μ,λ), and undistortion solvers U(μ, λ), respectively, where μ and λ indicate the number of distortion terms in the numerator and denominator, respectively.

We consider that an initial pose P is given as an input and distortion parameters and its intrinsic parameters are assumed to be unknown. This scenario naturally arises when the intrinsic parameters of the mobile device are unknown or poorly calibrated. During GNSS outages, GPS and the IMU subsystem may guide in estimating the pose with respect to a global, or at least pre-defined, coordinate system. This pose may then be exploited as an input to the solver. In this way, the solver only needs to solve the unknown intrinsic parameters and the distortion coefficients, which greatly simplifies the problem, and reduces computational requirements. Furthermore, it benefits from requiring fewer points, which reduces the number of necessary iterations if a RANSAC-like framework is applied.

Since the rotation and translation is assumed to be known from the pose, qⱼ:=π(RXⱼ+t), reducing the undistortion model (2) to

$$\frac{1 + {\sum }_{i} {{μ}_{i} ( \frac{{r}_{j}}{f} )}^{2 i}}{1 + {\sum }_{i} {{μ}_{i} ( \frac{{r}_{j}}{f} )}^{2 i}} \cdot \frac{1}{f} {x}_{j} = {q}_{j} \qquad ( 5 )$$

where f is the focal length and rⱼ is the radial distance of the 2D image point xⱼ to the distortion centre, when applying the general rational model (4), with rⱼ=∥xⱼ∥ and focal length being the principal intrinsic parameter. After a change of variables, μ̅ᵢ [symbol] μf²ⁱ and λ̅ᵢ [symbol] λᵢf²ⁱ⁻¹ one obtains

$$\frac{1 + {\sum }_{i} {\overline{μ}}_{i} {r}_{j}^{2 i}}{f + {\sum }_{i} {\overline{λ}}_{i} {r}_{j}^{2 i}} {x}_{j} = {q}_{j} . \qquad ( 6 )$$

In the general case, more than one point is required to solve the problem, therefore we seek to minimize

$${min}_{f , \overline{λ} , \overline{μ}} {\sum }_{j} {‖ ( 1 + {\sum }_{i} {\overline{μ}}_{i} {r}_{j}^{2 i} ) {x}_{j} - ( f + {\sum }_{i} {\overline{λ}}_{i} {r}_{j}^{2 i} ) {q}_{j} ‖}^{2} . \qquad ( 7 )$$

This formulation has the further benefit of being linear in the unknowns, as well as handling the overdetermined case, which is necessary for non-minimal samples. Similarly, for distortion models, we instead minimize

$${min}_{f , λ , \overline{μ}} {\sum }_{j} {‖ ( 1 + {\sum }_{i} {λ}_{i} {r}_{j}^{2 i} ) {x}_{j} - ( f + {\sum }_{i} {\overline{μ}}_{i} {r}_{j}^{2 i} ) {q}_{j} ‖}^{2} , \qquad ( 8 )$$

where a change of variables only applies to the μᵢ coefficients. The expressions (7) and (8) can each be written compactly (as mentioned for step 44b above) as

$${min}_{θ} {‖ M θ - b ‖}^{2} , \qquad ( 9 )$$

where θ is a vector representation of the unknowns and M varies depending on the distortion model. Optionally, a small dampening factor is added to the distortion parameters to prevent them from overfitting, i.e.

$${min}_{θ} {‖ M θ - b ‖}^{2} + ϵ {‖ λ ‖}^{2} + ϵ {‖ μ ‖}^{2} , \qquad ( 10 )$$

for ϵ>0. Note that, in minimal cases, the solution to (9) is simply obtained by 0=M⁻¹b. Two equations are given per point correspondences, hence all distortion models with an even number of parameters are minimal. For the case of odd number of parameters, one may can discard one equation, or solve the normal equations related to (9).

Tangential distortion stems from improper alignment of sensor and lens system. In the prior art, there are no minimal solvers that consider tangential distortion. This is most likely due to the additional unknowns introduced, causing the solvers to be larger and slower. Furthermore, radial distortion is the most prominent distortion artifact today, as automated or semi-automated alignment of image sensors and camera optics are used in many production lines; however, cheaper electronics components may not be as rigorously tested. Many of these components reach consumer markets, of which SLAM and positioning are becoming relevant applications.

The first-order tangential distortion terms include two tangential parameters p₁, p₂. The tangential parameters function as additional corrections to the ideal projection. This captures asymmetries such as tilt or decentering in the lens, which can cause an otherwise symmetric distortion pattern to become skewed.

Remember xⱼ, qⱼ ∈ [symbol] , which we explicitly express as

$${x}_{j} = [ \begin{matrix}{x}_{1 , j} \\ {x}_{2 , j}\end{matrix} ] and {q}_{j} = [ \begin{matrix}{q}_{1 , j} \\ {q}_{2 , j}\end{matrix} ] . \qquad ( 11 )$$

With the same notation as before, considering the distortion model with λᵢ ≡0,

$$( 12 )$$

$${min}_{f , {c}_{1} , {c}_{2} , \overline{μ} , {p}_{1} , {p}_{2}} {\sum }_{j} {‖ [ \begin{matrix}{x}_{1 , j} - {c}_{1} - ( f + {\sum }_{i} {\overline{μ}}_{i} {r}_{j}^{2 i} ) {q}_{1 , j} - 2 {p}_{1} {q}_{1 , j} {q}_{2 , j} - {p}_{2} ( {r}_{j}^{2} + 2 {q}_{1 , j}^{2} ) \\ {x}_{2 , j} - {c}_{2} - ( f + {\sum }_{i} {\overline{μ}}_{i} {r}_{j}^{2 i} ) {q}_{2 , j} - {p}_{1} ( {r}_{j}^{2} + 2 {q}_{2 , j}^{2} ) - 2 {p}_{2} {q}_{1 , j} {q}_{2 , j}\end{matrix} ] ‖}^{2} ,$$

where (c₁, c₂) is the principal point, here assumed unknown. With a single radial distortion coefficient, there are six unknowns, hence three 2D-3D correspondences are necessary to solve the system. In particular, we get

$$( 13 )$$

$${min}_{f , {c}_{1} , {c}_{2} , \overline{μ} , {p}_{1} , {p}_{2}} {‖ [ \begin{matrix}{x}_{1 , 1} - {c}_{1} - ( f + \overline{μ} {r}_{1}^{2} ) {q}_{1 , 1} - 2 {p}_{1} {q}_{1 , 1} {q}_{2 , 1} - {p}_{2} ( {r}_{1}^{2} + 2 {q}_{1 , 1}^{2} ) \\ {x}_{2 , 1} - {c}_{2} - ( f + \overline{μ} {r}_{1}^{2} ) {q}_{2 , 1} - {p}_{1} ( {r}_{1}^{2} + 2 {q}_{2 , 1}^{2} ) - 2 {p}_{2} {q}_{1 , 1} {q}_{2 , 1} \\ {x}_{1 , 2} - {c}_{1} - ( f + \overline{μ} {r}_{2}^{2} ) {q}_{1 , 2} - 2 {p}_{1} {q}_{1 , 2} {q}_{2 , 2} - {p}_{2} ( {r}_{2}^{2} + 2 {q}_{1 , 2}^{2} ) \\ {x}_{2 , 2} - {c}_{2} - ( f + \overline{μ} {r}_{2}^{2} ) {q}_{2 , 2} - {p}_{1} ( {r}_{2}^{2} + 2 {q}_{2 , 2}^{2} ) - 2 {p}_{2} {q}_{1 , 2} {q}_{2 , 2} \\ {x}_{1 , 3} - {c}_{1} - ( f + \overline{μ} {r}_{3}^{2} ) {q}_{1 , 3} - 2 {p}_{1} {q}_{1 , 3} {q}_{2 , 3} - {p}_{2} ( {r}_{3}^{2} + 2 {q}_{1 , 3}^{2} ) \\ {x}_{2 , 3} - {c}_{2} - ( f + \overline{μ} {r}_{3}^{2} ) {q}_{2 , 3} - {p}_{1} ( {r}_{3}^{2} + 2 {q}_{2 , 3}^{2} ) - 2 {p}_{2} {q}_{1 , 3} {q}_{2 , 3}\end{matrix} ] ‖}^{2} ,$$

which we may write as

$$( 14 )$$

$${min}_{f , {c}_{1} , {c}_{2} , \overline{μ} , {p}_{1} , {p}_{2}} {‖ - [ \begin{matrix}1 & 0 & {q}_{1 , 1} & {q}_{1 , 1} {r}_{1}^{2} & 2 {q}_{1 , 1} {q}_{2 , 1} & {r}_{1}^{2} + 2 {q}_{1 , 1}^{2} \\ 0 & 1 & {q}_{2 , 1} & {q}_{2 , 1} {r}_{1}^{2} & {r}_{1}^{2} + 2 {q}_{2 , 1}^{2} & 2 {q}_{1 , 1} {q}_{2 , 1} \\ 1 & 0 & {q}_{1 , 2} & {q}_{1 , 2} {r}_{2}^{2} & 2 {q}_{1 , 2} {q}_{2 , 2} & {r}_{2}^{2} + 2 {q}_{1 , 2}^{2} \\ 0 & 1 & {q}_{2 , 2} & {q}_{2 , 2} {r}_{2}^{2} & {r}_{2}^{2} + 2 {q}_{2 , 2}^{2} & 2 {q}_{1 , 2} {q}_{2 , 2} \\ 1 & 0 & {q}_{1 , 3} & {q}_{1 , 3} {r}_{3}^{2} & 2 {q}_{1 , 3} {q}_{2 , 3} & {r}_{3}^{2} + 2 {q}_{1 , 3}^{2} \\ 0 & 1 & {q}_{2 , 3} & {q}_{2 , 3} {r}_{3}^{2} & {r}_{3}^{2} + 2 {q}_{2 , 3}^{2} & 2 {q}_{1 , 3} {q}_{2 , 3}\end{matrix} ] [ \begin{matrix}{c}_{1} \\ {c}_{2} \\ f \\ \overline{μ} \\ {p}_{1} \\ {p}_{2}\end{matrix} ] + [ \begin{matrix}{x}_{1 , 1} \\ {x}_{2 , 1} \\ {x}_{1 , 2} \\ {x}_{2 , 2} \\ {x}_{1 , 3} \\ {x}_{2 , 3}\end{matrix} ] ‖}^{2} ,$$

which has the same form as before, i.e. the unknowns being linear.

A couple of examples will now be presented to illustrate how radial distortion can be determined for a match set.

Let us consider the case U(0,1) where two unknowns are sought: the focal length f and the (normalized) distortion parameter λ̅. In this case, a single match set of a 2D-3D correspondence is enough (hence indices are omitted) and (7) becomes

$$( 15 )$$

$${min}_{f , \overline{λ}} {‖ x - ( f + \overline{λ} {r}^{2} ) q ‖}^{2} = {min}_{f , \overline{λ}} {‖ - [ \begin{matrix}{q}_{1} \\ {q}_{2}\end{matrix} ] f - {r}^{2} [ \begin{matrix}{q}_{1} \\ {q}_{2}\end{matrix} ] \overline{λ} + [ \begin{matrix}{x}_{1} \\ {x}_{2}\end{matrix} ] ‖}^{2} = {min}_{f , \overline{λ}} {‖ - {[ \begin{matrix}{q}_{1} & {r}^{2} {q}_{1} \\ {q}_{2} & {r}^{2} {q}_{2}\end{matrix} ]}_{:= M} [ \begin{matrix}f \\ \overline{λ}\end{matrix} ] + {[ \begin{matrix}{x}_{1} \\ {x}_{2}\end{matrix} ]}_{:= - b} ‖}^{2} .$$

In a more elaborate example, consider D(1,1) which requires two match sets of 2D-3D correspondences, which upon using all available data, is overdetermined. Now (8) becomes

$${min}_{f , λ , \overline{μ}} {‖ ( 1 + λ {r}_{1}^{2} ) {x}_{1} - ( f + \overline{μ} {r}_{1}^{2} ) {q}_{1} ‖}^{2} + {‖ ( 1 + λ {r}_{2}^{2} ) {x}_{2} - ( f + \overline{μ} {r}_{2}^{2} ) {q}_{2} ‖}^{2} . \qquad ( 16 )$$

We may vectorize this expression

$$( 17 )$$

$${min}_{f , λ , \overline{μ}} {‖ [ \begin{matrix}( 1 + λ {r}_{1}^{2} ) {x}_{1} - ( f + \overline{μ} {r}_{1}^{2} ) {q}_{1} \\ ( 1 + λ {r}_{2}^{2} ) {x}_{2} - ( f + \overline{μ} {r}_{2}^{2} ) {q}_{2}\end{matrix} ] ‖}^{2} = {min}_{f , λ , \overline{μ}} {‖ [ \begin{matrix}( 1 + λ {r}_{1}^{2} ) {x}_{1 , 1} - ( f + \overline{μ} {r}_{1}^{2} ) {q}_{1 , 1} \\ ( 1 + λ {r}_{1}^{2} ) {x}_{2 , 1} - ( f + \overline{μ} {r}_{1}^{2} ) {q}_{2 , 1} \\ ( 1 + λ {r}_{2}^{2} ) {x}_{1 , 2} - ( f + \overline{μ} {r}_{2}^{2} ) {q}_{1 , 2} \\ ( 1 + λ {r}_{2}^{2} ) {x}_{2 , 2} - ( f + \overline{μ} {r}_{2}^{2} ) {q}_{2 , 2}\end{matrix} ] ‖}^{2} ,$$

which in turn can be written as

$${min}_{f , λ , \overline{μ}} {‖ - [ \begin{matrix}{q}_{1 , 1} & {q}_{1 , 1} {r}_{1}^{2} & - {x}_{1 , 1} {r}_{1}^{2} \\ {q}_{2 , 1} & {q}_{2 , 1} {r}_{1}^{2} & - {x}_{2 , 1} {r}_{1}^{2} \\ {q}_{1 , 2} & {q}_{1 , 2} {r}_{2}^{2} & - {x}_{1 , 2} {r}_{2}^{2} \\ {q}_{2 , 2} & {q}_{2 , 2} {r}_{2}^{2} & - {x}_{2 , 2} {r}_{2}^{2}\end{matrix} ] [ \begin{matrix}f \\ \overline{μ} \\ λ\end{matrix} ] + [ \begin{matrix}{x}_{1 , 1} \\ {x}_{2 , 1} \\ {x}_{1 , 2} \\ {x}_{2 , 2}\end{matrix} ] ‖}^{2} . \qquad ( 18 )$$

In the general case for distortion models D(M, N) with K match sets, we get

$$( 19 )$$

$$M = [ \begin{matrix}{q}_{1 , 1} & {q}_{1 , 1} {r}_{1}^{2} & {q}_{1 , 1} {r}_{1}^{4} & … & {q}_{1 , 1} {r}_{1}^{2 M} & - {x}_{1 , 1} {r}_{1}^{2} & - {x}_{1 , 1} {r}_{1}^{4} & … & - {x}_{1 , 1} {r}_{1}^{2 N} \\ {q}_{2 , 1} & {q}_{2 , 1} {r}_{1}^{2} & {q}_{2 , 1} {r}_{1}^{4} & … & {q}_{2 , 1} {r}_{1}^{2 M} & - {x}_{2 , 1} {r}_{1}^{2} & - {x}_{2 , 1} {r}_{1}^{4} & … & - {x}_{2 , 1} {r}_{1}^{2 N} \\ {q}_{1 , 2} & {q}_{1 , 2} {r}_{2}^{2} & {q}_{1 , 2} {r}_{2}^{4} & … & {q}_{1 , 2} {r}_{2}^{2 M} & - {x}_{1 , 2} {r}_{2}^{2} & - {x}_{1 , 2} {r}_{2}^{4} & … & - {x}_{1 , 2} {r}_{1}^{2 N} \\ {q}_{2 , 2} & {q}_{2 , 2} {r}_{2}^{2} & {q}_{2 , 2} {r}_{2}^{4} & … & {q}_{2 , 2} {r}_{2}^{2 M} & - {x}_{2 , 2} {r}_{2}^{2} & - {x}_{2 , 2} {r}_{2}^{4} & … & - {x}_{2 , 2} {r}_{1}^{2 N} \\ ⋮ & ⋮ & ⋮ & ⋱ & ⋮ & ⋮ & ⋮ & ⋱ & ⋮ \\ {q}_{1 , K} & {q}_{1 , K} {r}_{K}^{2} & {q}_{1 , K} {r}_{K}^{4} & … & {q}_{1 , K} {r}_{K}^{2 M} & - {x}_{1 , K} {r}_{K}^{2} & - {x}_{1 , K} {r}_{K}^{4} & … & - {x}_{1 , K} {r}_{K}^{2 N} \\ {q}_{2 , K} & {q}_{2 , K} {r}_{K}^{2} & {q}_{2 , K} {r}_{K}^{4} & … & {q}_{2 , K} {r}_{K}^{2 M} & - {x}_{2 , K} {r}_{K}^{2} & - {x}_{2 , K} {r}_{K}^{4} & … & - {x}_{2 , K} {r}_{K}^{2 N}\end{matrix} ] ,$$

where the vector of unknowns is of length M+N+1, and

$$b = [ \begin{matrix}{x}_{1 , 1} \\ {x}_{2 , 1} \\ {x}_{1 , 2} \\ {x}_{2 , 2} \\ ⋮ \\ {x}_{1 , K} \\ {x}_{2 , K}\end{matrix} ] , \qquad ( 20 )$$

which has a solution if and only if 2K≥M+N+1. The undistortion case unravels in a similar manner.

FIG. 6 is a schematic diagram showing functional modules of the calibration determiner 1 of FIGS. 2A-C according to one embodiment. The modules are implemented using software instructions such as a computer program executing in the calibration determiner 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 5A-C.

An image acquirer 70 corresponds to step 40. A localisation data receiver step 72 corresponds to step 42. A calibration parameter computer 74 corresponds to step 44. A match set determiner 74a corresponds to sub-step 44a. A calibration parameter calculator 74b corresponds to sub-step 44b. A repeater corresponds to step 46. An outlier remover 78 corresponds to step 48. A refiner 80 corresponds to step 50.

FIG. 7 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

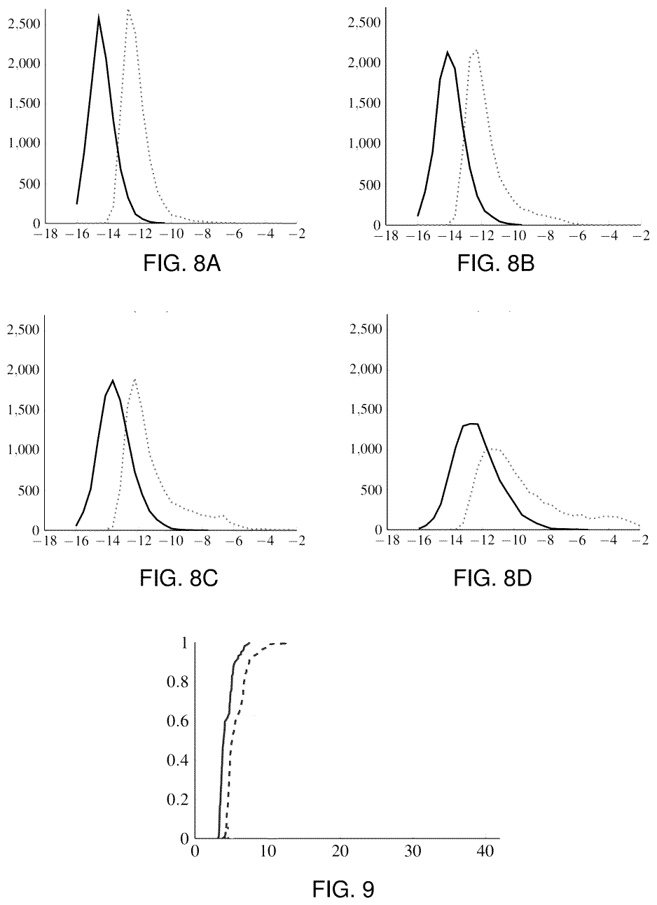

FIGS. 8A-D are graphs illustrating distribution of pose errors for embodiments presented herein compared to the prior art for a few sample cases. The graphs are based on synthetic data with no noise and is used to demonstrate the numerical stability of the solver. The solid line shows distribution of pose errors for embodiments presented herein and the dotted line shows distribution of pose errors according to the methods of Larsson et al (see background above). The horizontal axis represents log 10 of the pose error. The vertical axis represents the number of samples at each pose error level.

FIG. 8A plots pose error distribution for an example of a distortion calculation where μ is one and λ is zero. FIG. 8B plots pose error distribution for an example of a distortion calculation where μ is two and λ is zero. FIG. 8C plots pose error distribution for an example of a distortion calculation where μ is three and λ is zero. FIG. 8D plots pose error distribution for an example of a distortion calculation where μ is three and λ is three.

The performance of embodiments presented herein is evident from FIGS. 8A-D, where the numerical stability is significantly better for embodiments presented herein for all the calculated examples.

FIG. 9 is a schematic graph illustrating cumulative distribution of execution time for embodiments presented herein compared to the prior art. The solid line shows distribution of execution time for embodiments presented herein and the dotted line shows distribution of execution times according to the methods of Larsson et al (see background). The horizontal axis represents execution time in milliseconds. The vertical axis represents cumulative distribution. The calculations are based on an example of a distortion calculation where μ is 1 and λ is zero.

Again, the superior performance of embodiments presented herein is clearly seen, where execution times is markedly lower.

According to embodiments presented herein, by exploiting known pose information when determining calibration parameters, this can be achieved more accurately and quicker than in the prior art. This enable calibration to be performed at less computational cost, enabling the calibration to be performed in the mobile device, and even repetitively when needed. Furthermore, embodiments presented herein do not rely on any particular visual setting, such as a checkerboard, to arrive at the calibration parameters; instead, by exploiting the known pose, the calibration parameters can be computed based on any environment where a 3D map can be used for feature mapping of a captured image.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for computing at least one calibration parameter of a camera, the method being performed by a calibration determiner, the method comprising:
acquiring an image captured by a camera;
receiving localisation data comprising a pose, consisting of a position and orientation in a pre-defined coordinate system, the pose concerning a point being fixed in relation to the camera; and
computing at least one calibration parameter for the camera based on the image and the localisation data,
wherein the at least one calibration parameter comprises at least one intrinsic parameter and/or at least one distortion coefficient for the camera.

2. The method of claim 1, wherein computing the at least one calibration parameter comprises:
determining at least one match set, in which one 3D point of a feature in a 3D space of the pre-defined coordinate system, matches a corresponding 2D image point coordinate of the feature in the image; and
calculating the at least one calibration parameter for the camera based on the at least one match set and the pose.

3. The method of claim 2, wherein calculating the at least one calibration parameter comprises determining, for each match set, a 2D projection of the 3D point of the feature, onto a plane corresponding to the image, and
wherein the 2D projection is based on the pose; and wherein the at least one calibration parameter is calculated based on comparing the 2D projection of the 3D point of the feature with 2D image point coordinate of the feature.

4. The method of claim 3, wherein the 2D projection is computed based on a pinhole camera model.

5. The method of claim 1, wherein computing the at least one calibration parameter comprises repeatedly computing the at least one calibration parameter until an exit condition is true to obtain a plurality of candidate sets of calibration parameter(s),
the method further comprises:
selecting a set of calibration parameter(s) from the plurality of candidate sets of calibration parameter(s).

6. The method according of claim 1, wherein the localisation data is based on sensor data from an inertial measurement unit being fixed in relation to the camera, and a previously known pose based on a global navigation satellite system, GNSS, the sensor data at least covering a time after the previously known pose.

7. The method of claim 1, wherein the localisation data is determined using orientation and/or distance indicators that are determined based on radio frequency, RF, signals from one or more fixed RF transceiver stations.

8. The method of claim 1, wherein computing the at least one calibration parameter comprises estimating at least one parameter of a radial distortion of the camera, based on finding a minimum of a linear expression.

9. The method of claim 8, wherein computing the at least one calibration parameter comprises
determining at least one match set, in which one 3D point of a feature in a 3D space of the pre-defined coordinate system, matches a corresponding 2D image point coordinate of the feature in the image;
calculating the at least one calibration parameter for the camera based on the at least one match set and the pose; and
estimating a vector θ comprising the at least one calibration parameters according to the expression:
$${min}_{θ} {‖ M θ - b ‖}^{2} ,$$
where M is a matrix and b is a vector, wherein the elements of M and b are derived from the at least one match set.

10. The method of claim 9, wherein the length of vector b is the same as the length of vector θ, and wherein the matrix M is a square matrix whose sides are the same length as the length of vector θ.

11. The method of claim 1, wherein the at least one calibration parameter comprises tangential distortion parameters.

12. The method of claim 1, further comprising:
refining initial pose estimates over an established inlier set.

13. A calibration determiner for computing at least one calibration parameter of a camera, the calibration determiner comprising:
processing circuitry; and
memory coupled to the processing circuitry and having instructions stored therein that, when executed by the processing circuitry, cause the calibration determiner to:
acquire an image captured by a camera;
receive localisation data comprising a pose, consisting of a position and orientation in a pre-defined coordinate system, the pose concerning a point being fixed in relation to the camera; and
compute at least one calibration parameter for the camera based on the image and the localisation data, wherein the at least one calibration parameter comprises at least one intrinsic parameter and/or at least one distortion coefficient for the camera.

14. The calibration determiner of claim 13, wherein the instructions to compute at least one calibration parameter comprise instructions that, when executed by the processing circuitry, cause the calibration determiner to:
determine at least one match set, in which one 3D point of a feature in a 3D space of the pre-defined coordinate system, matches a corresponding 2D image point coordinate of the feature in the image; and
calculate the at least one calibration parameter for the camera based on the at least one match set and the pose.

15. The calibration determiner of claim 14, wherein the instructions to calculate at least one calibration parameter comprise instructions that, when executed by the processing circuitry, cause the calibration determiner to determine, for each match set, a 2D projection of the 3D point of the feature, onto a plane corresponding to the image, and
wherein the 2D projection is based on the pose; and wherein the at least one calibration parameter is calculated based on comparing the 2D projection of the 3D point of the feature with 2D image point coordinate of the feature.

16. The calibration determiner of claim 15, wherein the 2D projection is computed based on a pinhole camera model.

17. The calibration determiner of claim 13, further comprising instructions that, when executed by the processing circuitry, cause the calibration determiner to repeat the instructions to compute at least one calibration parameter until an exit condition is true to obtain a plurality of candidate sets of calibration parameter(s), and
wherein the calibration determiner further comprises instructions that, when executed by the processing circuitry, cause the calibration determiner to select a set of calibration parameter(s) from the plurality of candidate sets of calibration parameter(s).

18. The calibration determiner of claim 13, wherein the localisation data is based on sensor data from an inertial measurement unit being fixed in relation to the camera, and a previously known pose based on a global navigation satellite system, GNSS, the sensor data at least covering a time after the previously known pose.

19. The calibration determiner of claim 13, wherein the localisation data is determined using orientation and/or distance indicators that are determined based on radio frequency, RF, signals from one or more fixed RF transceiver stations.

20. The calibration determiner of claim 13, wherein the instructions to compute the at least one calibration parameter comprise instructions that, when executed by the processing circuitry, cause the calibration determiner to estimate at least one parameter of a radial distortion of the camera, based on finding a minimum of a linear expression.

21. The calibration determiner of claim 20, wherein the instructions to compute the at least one calibration parameter comprises instructions that, when executed by the processing circuitry, cause the calibration determiner to:
determine at least one match set, in which one 3D point of a feature in a 3D space of the pre-defined coordinate system, matches a corresponding 2D image point coordinate of the feature in the image;
calculate the at least one calibration parameter for the camera based on the at least one match set and the pose; and
estimate a vector θ comprising the at least one calibration parameters according to the expression:
$${min}_{θ} {‖ M θ - b ‖}^{2} ,$$
where M is a matrix and b is a vector, wherein the elements of M and b are derived from the at least one match set.

22. The calibration determiner of claim 21, wherein the length of vector b is the same as the length of vector θ, and wherein the matrix M is a square matrix whose sides are the same length as the length of vector θ.

23. The calibration determiner of claim 13, wherein the at least one calibration parameter comprises tangential distortion parameters.

24. The calibration determiner of claim 13, further comprising instructions that, when executed by the processing circuitry, cause the calibration determiner to refine initial pose estimates over an established inlier set.

25. A non-transitory computer readable medium having instructed stored therein that, when executed by processing circuitry of a calibration determiner, cause the calibration determiner to:
acquire an image captured by a camera;
receive localisation data comprising a pose, consisting of a position and orientation in a pre-defined coordinate system, the pose concerning a point being fixed in relation to the camera; and
compute at least one calibration parameter for the camera based on the image and the localisation data, wherein the at least one calibration parameter comprises at least one intrinsic parameter and/or at least one distortion coefficient for the camera.
